(19) United States
(12) Patent Application Publication
(10) Pub. No.: US 2026/0143291 A1
(43) Pub. Date: May 21, 2026

(54) EVENT BROADCASTING SYSTEM

(71) Applicant: InXtream S.L., Getafe (ES)

(72) Inventor: Oscar BERNARDINO DE CASTRO, Getafe (ES)

(73) Assignee: InXtream S.L., Getafe (ES)

(21) Appl. No.: 18/953,484

(22) Filed: Nov. 20, 2024

(51) Int. Cl. H04R 27/00

(52) U.S. Cl. CPC H04R 27/00

(57) ABSTRACT

At least one embodiment relates to an event broadcast and relay system. There is an event relay system that transmits an event taking place inside a booth in real time to users at a given distance. Specifically, what the invention proposes, as stated above, is an event relay system comprising a soundproof booth both from the outside to the inside and from the inside to the outside which broadcasts said event taking place inside it to a plurality of receivers carried by users within a given range area.

### OBJECT OF THE INVENTION

The object of the present invention is, as the title of the invention states, an event relay system, which transmits the event that takes place inside a booth. This is an innovation which, within the current state of the art, provides advantages hitherto unknown. The present invention is characterized by the special functional and constructive characteristics of the elements that form part of-the device in such a way that all of them contribute to the achievement of an event broadcasting system.

### FIELD OF THE ART

The present invention is therefore circumscribed within the field of equipment and systems for the realization of events and staging, preferably musical events.

### BACKGROUND TO THE INVENTION

As a reference to the current state of the art, it should be noted that, although different event relay systems are known, no other system is known to exist that has the same or similar structural and constitutive technical characteristics to those of the invention claimed herein.

### EXPLANATION OF THE INVENTION

The object of the invention is an event relay system that transmits an event taking place inside a booth in real time to users at a given distance. Specifically, what the invention proposes, as stated above, is an event relay system comprising a soundproof booth both from the outside to the inside and from the inside to the outside which broadcasts said event taking place inside it to a plurality of receivers carried by users within a given range area. The booth is transparent, which allows users to see fron1 outside the booth the event taking place inside it and at the same time to hear or see the event on their receivers without distortion and in real time. The receivers are preferably an electronic device such as a smart phone, tablet or similar to which a specific software application or a headset has been installed. Unless otherwise stated, all technical and scientific elements used herein have the meaning usually understood by a person skilled in the art to which this invention pertains. In the practice of the present invention, procedures and materials similar or equivalent to those described herein may be used.

### BRIEF DESCRIPTION OF THE DRAWINGS

For the sake of completeness and in order to assist in a better understanding of the features of the invention, the present description is accompanied, as an integral part thereof, by figures in which, for illustrative and non-limiting purposes, the following has been depicted:

FIG. 1 is a perspective representation of the event relay system; and

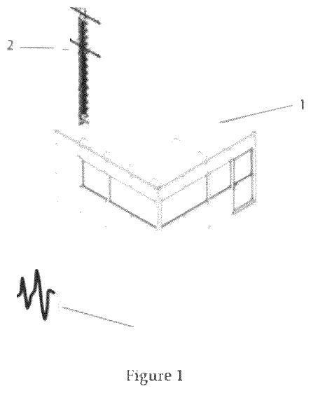

FIG. 2 is a perspective representation of the event relay system 5 with a representation of the range area (4).

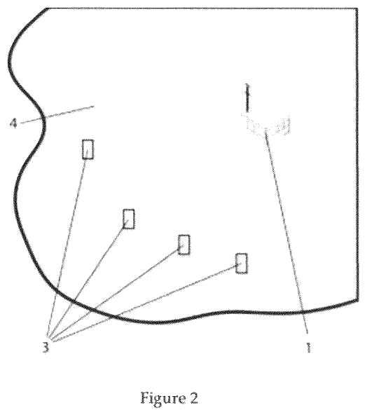

### DETAILED EXPOSITION OF AN EMBODIMENT OF THE INVENTION.

In view of the figures, a preferred but non-limiting embodiment of the proposed invention, which consists of an event relay system, is described below.

As can be seen in the figures, the event broadcasting system comprises a booth (1) that is soundproofed both from the outside towards the inside and from the inside towards the outside. Said booth (1) is enabled for the live performance of musical events in its interior, being configured so that the interior can be seen from the outside, as well as said live performance of musical events.

The booth (1) comprises sound and visual recording means, which by means of means of retransmission (2) of the recordings are broadcast in real time, to a plurality of receivers (3) located in a range area (4).

Preferably but not limited to, the means of retransmission (2) use radio frequency to transmit the recordings, specifically by means of Wi-Fi.

On the other hand, the cabin (1), if located outdoors, may include solar or wind energy production means to supplement its electricity consumption.

Depending on the mode of realization, the receivers (3) are preferably an electronic device such as a smart phone, tablet or similar to which a specific software application or a headset has been installed.

Having sufficiently described the nature of the present invention, as well as the manner of putting it into practice, it is not considered necessary to provide a more extensive explanation so that any person skilled in the art 1nay understand its scope and the advantages deriving therefrom, it being noted that, within its essential nature.

It may be put into practice in other embodiments which differ in detail from the one indicated by way of example, and to which the protection claimed will also apply provided that its fundamental principle is not altered, changed or modified.

1. An event broadcasting system, wherein:
a booth soundproofed both front the outside towards the inside and from the inside towards the outside, which is enabled for the live performance of musical events in its interior, being configured so that the interior can be seen from the outside, as well as said live performance of musical events, which comprises sound and visual recording means, which by means of means of retransmission means of the recordings are broadcast in real time, to a plurality of receivers located in a range area

2. The event retransmission system, according to claim 1 wherein the retransmission means is preferably, but not limited to, use radio frequency to transmit the recordings, specifically by means of a Wi-Fi signal.

3. The event broadcasting system, according to claim 1 wherein the booth includes solar or wind energy. production means that complement its electrical consumption.

4. The event broadcasting system, according to claim 1 wherein the receivers are preferably an electronic device such as a smart phone, tablet or similar to which a specific software application has been installed.

5. The event broadcasting system, according to claim 1, wherein the receivers are headphones.
